(19) United States
(12) Patent Application Publication
(10) Pub. No.: US 2016/0332102 A1
(43) Pub. Date: Nov. 17, 2016

(54) LOW-NOISE VIBRATION-REDUCTION WATER PURIFIER AND METHOD OF INSTALLING THE SAME

(71) Applicant: Xiamen Runner Industrial Corporation, Xiamen (CN)

(72) Inventors: Guo-qiang Yu, Xiamen (CN); Jing-ming Li, Xiamen (CN); Feng-shun Zhan, Xiamen (CN)

(21) Appl. No.: 15/146,591

(22) Filed: May 4, 2016

(30) Foreign Application Priority Data
May 12, 2015 (CN) 201510236878.X

(51) Int. Cl. B01D 35/26; C02F 1/00; F04D 29/66; B01D 35/30

(52) U.S. Cl. CPC B01D 35/26; B01D 35/30; C02F 1/001; F04D 29/669; C02F 2201/002

(57) ABSTRACT

A low-noise vibration-reduction water purifier comprises: a shell body; a pump assembly, disposed vertically in the shell body, with its water input tube connected to a water pipe of faucet water, and with its water output tube connected to a filtering core L; a sound silencing cotton sleeve, sleeved around the water input tube and the water output tube; and a sound silencing cotton layer disposed between outer perimeter of the pump assembly and the shell body. The low-noise vibration-reduction water purifier is novel in design, simple in construction, capable of achieving vibration and noise reduction effectively, while adding comfort in operation. In addition, the low-noise vibration-reduction water purifier installation method can be used to realize installation in a simple manner, to facilitate convenient operation.

### BACKGROUND OF THE INVENTION

1. Field of the Invention

The present invention relates to a water purifier, and in particular to a low-noise vibration-reduction water purifier and method of installing the same.

2. The Prior Arts

Presently on the market, pump of water purifier adopts a side fixing approach to fix it on a wall. In this structure, plastic pad is placed between a pump and the fixing piece, to absorb and reduce vibration. However, this way of fixing is not ideal, for it can not eliminate the noise caused by vibrations of a pump.

The noise produced by the water purifier while working can be mainly attributed to two causes. The first cause is the mechanical noise produced by the pump in operation, this type of noise is rather difficult to eliminate. The second cause is the noise caused by the collisions of the main body, the water input tube and the water output tube, and other components in the pump while it is working. The existence of the noise mentioned could cause discomfort to the user.

Therefore, presently, the design of the water purifier is not quite satisfactory, and it leaves much room for improvement.

### SUMMARY OF THE INVENTION

In view of the problems and drawbacks of the prior art, the present invention provides a low-noise vibration-reduction water purifier and method of installing the same, that is novel in design, simple in construction, in achieving vibration and noise reduction effectively.

In order to achieve the objective mentioned above, the present invention provides a low-noise vibration-reduction water purifier, comprising: a shell body, a pump assembly, a sound silencing cotton sleeve, and a sound silencing cotton layer. Wherein, the pump assembly is disposed vertically in the shell body, with its water input tube connected to a water pipe of faucet water, and with its water output tube connected to a filtering core L. The sound silencing cotton sleeve is sleeved around the water input tube and the water output tube. And the sound silencing cotton layer is disposed between outer perimeter of the pump assembly and the shell body.

In an aspect of the present invention, in order to reduce vibrations, the pump assembly includes: a pump, and a seat rack. Wherein, the seat rack includes a bottom seat and a middle seat located above the bottom seat, and is used to position the pump. The pump is locked and fixed on the middle seat, while perimeter of the middle seat is provided with a plurality of through holes. In the through holes are each provided with an indent flange, below the indent flange is provided with a lower spring, that is disposed with its lower portion penetrating in a sinking hole of the bottom seat. Above the indent flange is provided with an upper spring. The bolt component is disposed to penetrate through the through hole and the sinking hole, such that the bolt component is disposed to press the upper spring and the lower spring, to fix the middle seat on the bottom seat elastically.

In another aspect of the present invention, the bolt component includes a bolt penetrating through the sinking hole and the through hole from bottom to top, and a positioning ring disposed on an upper end surface of the through hole, and a cap nut.

In a further aspect of the present invention, the positioning ring is of a hood shape, with its lower end surface pressing against an upper surface of the through hole, while the cap nut is pressed against an upper end surface of the positioning ring.

In yet another aspect of the present invention, the sound silencing cotton sleeve and the sound silencing cotton layer are each made of one of a following group consisting of: polyester cotton, sound proof cotton, centrifugal glass cotton, rock wool, and mineral wool.

In an aspect of the present invention, the connections between the water input tube, the water output tube, and the pump assembly are of an arc shape.

In another aspect of the present invention, the present invention also provides a low-noise vibration-reduction water purifier installation method, wherein the low-noise vibration-reduction water purifier includes a shell body; and a pump assembly, disposed vertically in the shell body, with its water input tube connected to a water pipe of faucet water, and with its water output tube connected to a filtering core L. Around the water input tube and the water output tube are each sleeved with a sound silencing cotton sleeve, while a sound silencing cotton layer is disposed between outer perimeter of the pump assembly and the shell body. As such the method includes following steps: in installation, firstly, placing the sound silencing cotton layer in an inner chamber of the pump assembly; next, sleeving the sound silencing cotton sleeve around and onto the water input tube and the water output tube of pump assembly, to ensure that the sound silencing cotton sleeve and the sound silencing cotton layer are fixedly positioned and not tends to slip; and finally inserting the pump assembly into the sound silencing cotton layer, to finish installation of the pump assembly in the shell body.

In a further aspect of the present invention, the pump assembly includes: a pump and a seat rack. Wherein, the seat rack includes a bottom seat, and a middle seat above the bottom seat, and is used to position the pump. The pump is locked and fixed on the middle seat, while perimeter of the middle seat is provided with a plurality of through holes, in the through holes are each provided with an indent flange. Below the indent flange is provided with a lower spring, that is disposed to penetrate into a sinking hole of the bottom seat, while above the indent flange is provided with an upper spring. A bolt component is disposed to penetrate through the through hole and the sinking hole, such that the bolt component is disposed to press the upper spring and the lower spring, to fix the middle seat onto the bottom seat. As such the method includes following steps: in installing the pump assembly, firstly, putting the lower spring into the sinking hole; next, placing the upper spring above the indent flange in the through holes; then, placing the pump fixed with the middle seat in advance into the bottom seat, to penetrate through the sinking hole and the through holes from bottom to top, to connect to the bolt component.

The operation principles of low-noise vibration-reduction water purifier of the present invention are described in detail as follows.

In application of water purifier, the pump assembly is disposed vertically. The pump itself is provided with an upper spring and a lower spring to absorb and reduce vibrations, so that the vibration of the pump will not be distributed to other components in the shell body. Around the pump assembly is provided with a sound silencing cotton layer, to absorb the mechanical noise while the pump is in operation. The water input tube and the water output tube of the pump are connected through an arc shape connection, to increase the length of water tube. Around the arc shape water tube is sleeved a section of sound silencing cotton sleeve, to eliminate the sway and vibration when the pump is working, this may also prevent the noise incurred by the resonance of the water tube and other components.

The vibration reduction principle of the pump assembly is realized through an upper spring, a lower spring, and a middle seat, to fix the pump on the bottom seat in suspension. In normal operation, a pump tends to vibrate in all directions. However, since the pump is connected only to the bottom seat, and spring is connected between the bottom seat and the middle seat, so that the vibrations of the pump in operation are absorbed and eliminated by the upper spring and lower spring. As such, vibrations will not be distributed to the bottom seat, to reduce significantly the vibrations and the noise incurred.

The low-noise vibration-reduction water purifier of the present invention is novel in design, simple in construction, in achieving vibration and noise reduction effectively, while adding comfort in operation. In addition, the low-noise vibration-reduction water purifier installation method can be used to realize installation in a simple manner, to facilitate convenient operation.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a structure of low-noise vibration-reduction water purifier according to the present invention;

FIG. 2 is an exploded view of a pump assembly according to the present invention;

FIG. 3 is a schematic diagram of a structure of a pump assembly according to the present invention;

FIG. 4 is an enlarged view of portion A of FIG. 3; and

FIG. 5 is a perspective view of a pump assembly according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

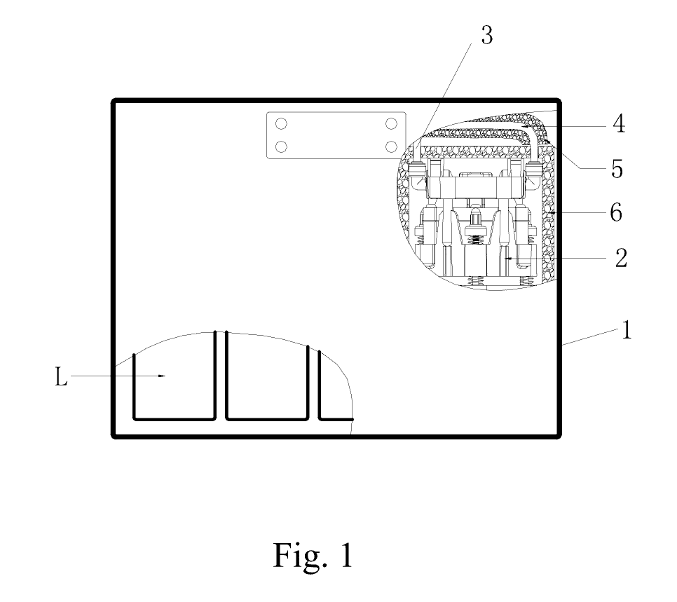

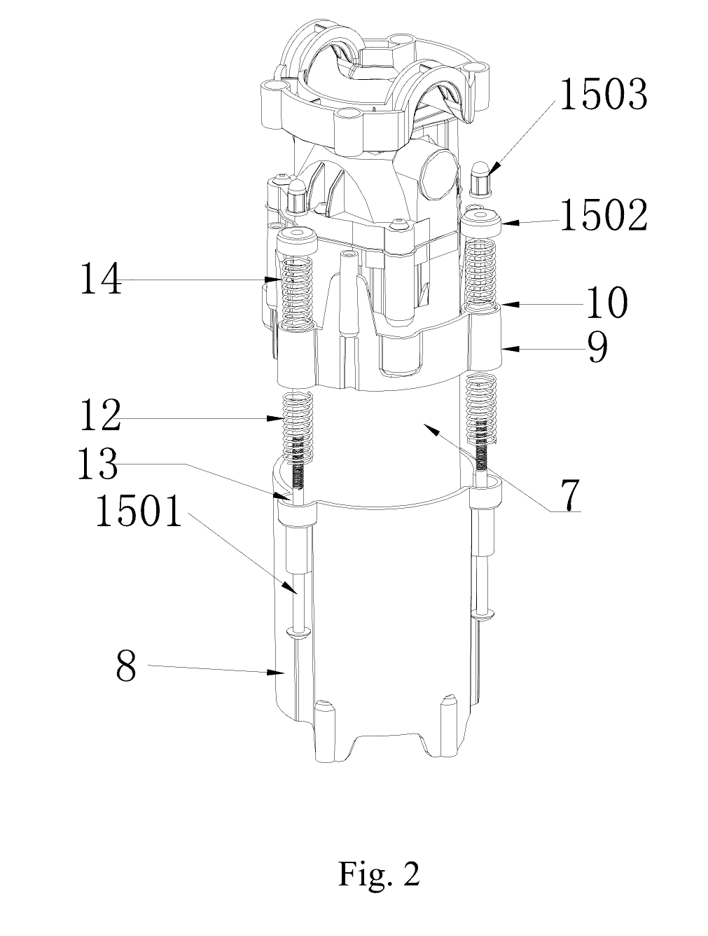

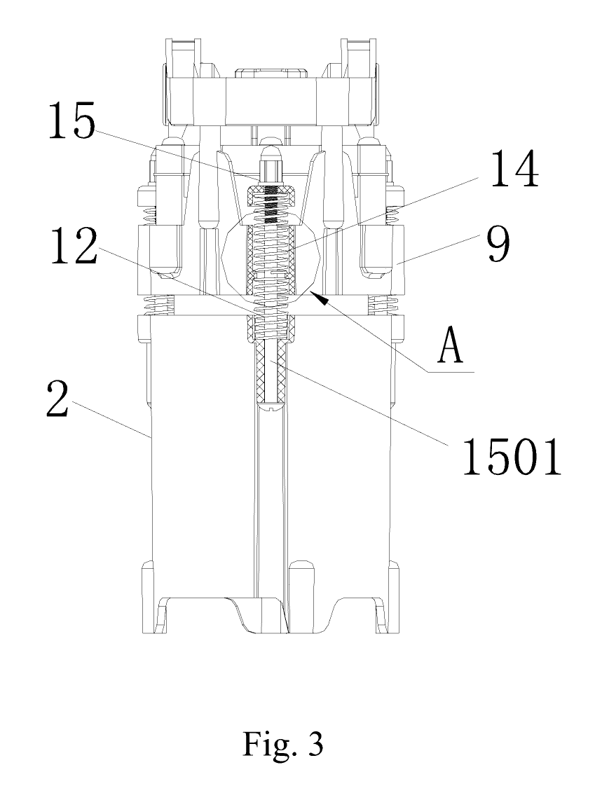

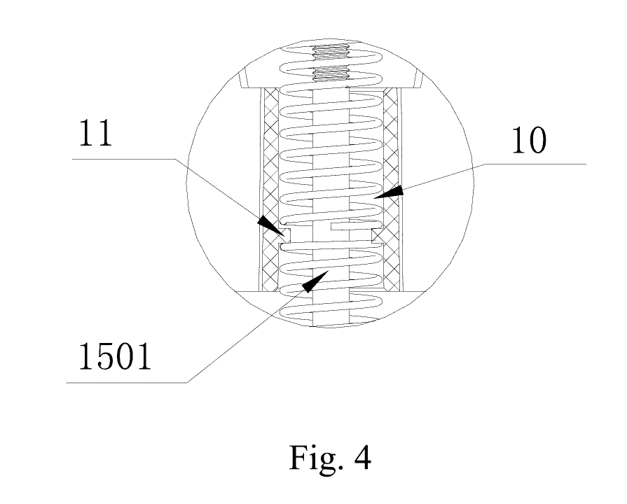

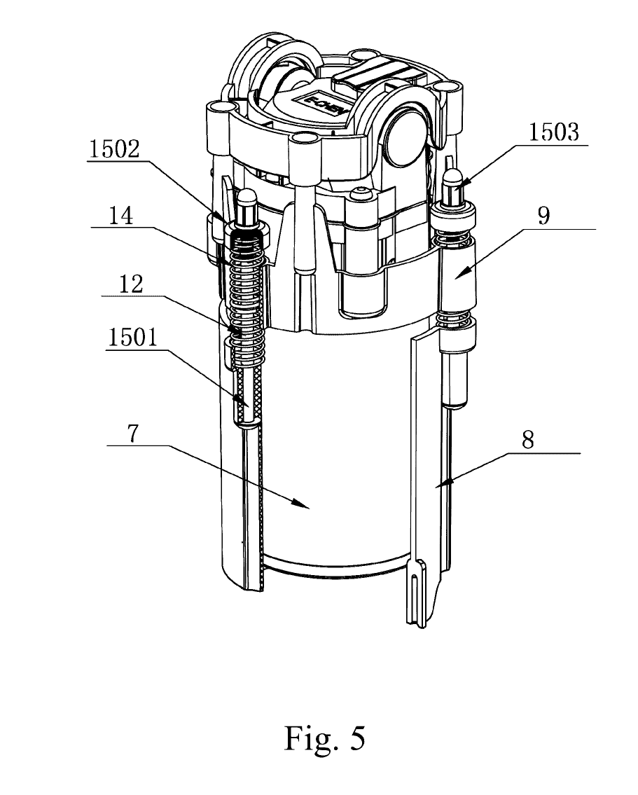

Refer to FIGS. 1 to 5 respectively for a schematic diagram of a structure of low-noise vibration-reduction water purifier according to the present invention; an exploded view of a pump assembly according to the present invention; a schematic diagram of a structure of a pump assembly according to the present invention; an enlarged view of portion A of FIG. 3; and a perspective view of a pump assembly according to the present invention.

As shown in FIGS. 1 to 5, the present invention provides a low-noise vibration-reduction water purifier, comprising: a shell body 1, a pump assembly 2, a sound silencing cotton sleeve 5, and a sound silencing cotton layer 6. Wherein, the pump assembly 2 is disposed vertically in the shell body 1, with its water input tube 3 connected to a water pipe of faucet water, and with its water output tube 4 connected to a filtering core L. The sound silencing cotton sleeve 5 is sleeved around the water input tube 3 and the water output tube 4. And the sound silencing cotton layer 6 is disposed between outer perimeter of the pump assembly 2 and the shell body 1.

In the structure mentioned above, in order to reduce vibrations, the pump assembly 2 includes: a pump 7, and a seat rack. Wherein, the seat rack includes a bottom seat 8 and a middle seat 9 located above, and is used to position the pump 7. The pump 7 is locked and fixed on the middle seat 9, while perimeter of the middle seat 9 is provided with a plurality of through holes 10. In the through holes 10 are each provided with an indent flange 11, below the indent flange 11 is provided with a lower spring 12, that is disposed with its lower portion penetrating into a sinking hole 13 of the bottom seat 8. Above the indent flange 11 is provided with an upper spring 14. The bolt component 15 is disposed to penetrate through the through hole 10 and the sinking hole 13, such that the bolt component 15 is disposed to press the upper spring 14 and the lower spring 12, to fix the middle seat 9 on the bottom seat 8.

The bolt component 15 includes a bolt 1501 penetrating through the sinking hole 13 and the through hole 10 from bottom to top, a positioning ring 1502 disposed on an upper end surface of the through hole 10, and a cap nut 1503.

The positioning ring 1502 is of a hood shape, with its lower end surface disposed to press against an upper surface of the through hole 10, while the cap nut 1503 is disposed to press against an upper end surface of the positioning ring 1502.

The sound silencing cotton sleeve 5 and the sound silencing cotton layer 6 are each made of one of a following group consisting of: polyester cotton, sound proof cotton, centrifugal glass cotton, rock wool, and mineral wool.

The connections between the water input tube 3, the water output tube 4, and the pump assembly 2 are of an arc shape.

The present invention also provides a low-noise vibration-reduction water purifier installation method, wherein the low-noise vibration-reduction water purifier includes a shell body 1; and a pump assembly 2, disposed vertically in the shell body 1, with its water input tube 3 connected to a water pipe of faucet water, and with its water output tube 4 connected to a filtering core L. Around the water input tube 3 and the water output tube 4 are each sleeved with a sound silencing cotton sleeve 5, while a sound silencing cotton layer 6 is disposed between outer perimeter of the pump assembly 2 and the shell body 1. As such, the method includes following steps: in installation, firstly, placing the sound silencing cotton layer 6 in an inner chamber of the pump assembly 2; next, sleeving the sound silencing cotton sleeve 5 around and onto the water input tube 3 and the water output tube 4 of pump assembly 2, to ensure that the sound silencing cotton sleeve 5 and the sound silencing cotton layer 6 are fixedly positioned and not tends to slip; and finally inserting the pump assembly 2 into the sound silencing cotton layer 6, to finish installation of the pump assembly 2 in the shell body 1.

The pump assembly 2 includes: a pump 7 and a seat rack. Wherein, the seat rack includes a bottom seat 8, and a middle seat 9 above the bottom seat 8, both are used to position the pump 7. The pump 7 is locked and fixed on the middle seat 9, while perimeter of the middle seat 9 is provided with a plurality of through holes 10, in the through holes 10 are each provided with an indent flange 11. Below the indent flange 11 is provided with a lower spring 12, that is disposed to penetrate into a sinking hole 13 of the bottom seat 8, while above the indent flange 11 is provided with an upper spring 14. A bolt component 15 is disposed to penetrate through the through hole 10 and the sinking hole 13, such that the bolt component 15 is disposed to press the upper spring 14 and the lower spring 12, to fix the middle seat 9 onto the bottom seat 8. As such the method includes following steps: in installing the pump assembly 2, firstly, putting the lower spring 12 into the sinking hole 13; next, placing the upper spring 14 above the indent flange 11 in the through holes 10; then, placing the pump 7 fixed with the middle seat 9 in advance into the bottom seat 8, to penetrate through the sinking hole 10 and the through holes 10 from bottom to top, to connect to the bolt component 15.

The operation principles of low-noise vibration-reduction water purifier of the present invention are described in detail as follows.

In application of the water purifier, the pump assembly 2 is disposed vertically. The pump 7 itself is provided with an upper spring 14 and a lower spring 12 to absorb and reduce vibrations, so that the vibration of the pump 7 will not be distributed to other components in the shell body 1. Around the pump assembly 2 is provided with a sound silencing cotton layer 6, to absorb the mechanical noise while the pump 7 is in operation. The water input tube 3 and the water output tube 4 of the pump 7 are connected through an arc shape connection, to increase the length of water tube. Around the arc shape water tube is sleeved a section of sound silencing cotton sleeve 5, to eliminate the sway and vibration when the pump 7 is working, this may also prevent the noise incurred by the resonance of the water tube and other components.

The vibration reduction principle of the pump assembly 2 is realized through an upper spring 14, a lower spring 12, and a middle seat 9, to fix the pump 7 on the bottom seat 8 in suspension. In normal operation, a pump 7 tends to vibrate in any directions. However, since the pump 7 is connected only to the bottom seat 8, and spring 7 is connected between the bottom seat 8 and the middle seat 9, so that the vibrations of the pump 7 in operation are absorbed and eliminated by the upper spring 14 and lower spring 12. As such, vibrations will not be distributed to the bottom seat 8, to reduce significantly the vibrations and the noise incurred.

The low-noise vibration-reduction water purifier of the present invention is novel in design, simple in construction, in achieving vibration and noise reduction effectively, while adding comfort in operation. In addition, the low-noise vibration-reduction water purifier installation method can be used to realize installation in a simple manner, to facilitate convenient operation.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A low-noise vibration-reduction water purifier, comprising:
a shell body;
a pump assembly, disposed vertically in the shell body, with its water input tube connected to a water pipe of faucet water, and with its water output tube connected to a filtering core;
a sound silencing cotton sleeve, sleeved around the water input tube and the water output tube; and
a sound silencing cotton layer, disposed between outer perimeter of the pump assembly and the shell body.

2. The low-noise vibration-reduction water purifier as claimed in claim 1, wherein the pump assembly includes:
a pump;
a seat rack, including a bottom seat, and a middle seat, and is used to position the pump, while the bottom seat is located below the middle seat;
wherein, the pump is locked and fixed on the middle seat, while perimeter of the middle seat is provided with a plurality of through holes, in the through holes are each provided with an indent flange, below the indent flange is provided with a lower spring, that is disposed with its lower portion penetrating into a sinking hole of the bottom seat, above the indent flange is provided with an upper spring, a bolt component is disposed to penetrate through the through hole and the sinking hole, such that the bolt component is disposed to press the upper spring and the lower spring, to fix them on the middle seat and the bottom seat respectively in an elastic way.

3. The low-noise vibration-reduction water purifier as claimed in claim 2, wherein the bolt component includes a bolt penetrating through the sinking hole and the through hole from bottom to top, a positioning ring disposed on an upper end surface of the through hole, and a cap nut.

4. The low-noise vibration-reduction water purifier as claimed in claim 3, wherein the positioning ring is of a hood shape, with its lower end surface pressing against an upper surface of the through hole, while the cap nut is pressed against an upper end surface of the positioning ring.

5. The low-noise vibration-reduction water purifier as claimed in claim 1, wherein the sound silencing cotton sleeve and the sound silencing cotton layer are each made of one of a following group consisting of: polyester cotton, sound proof cotton, centrifugal glass cotton, rock wool, and mineral wool.

6. The low-noise vibration-reduction water purifier as claimed in claim 1, wherein connections between the water input tube, the water output tube, and the pump assembly are of an arc shape.

7. A low-noise vibration-reduction water purifier installation method, wherein
the low-noise vibration-reduction water purifier includes a shell body; and a pump assembly, disposed vertically in the shell body, with its water input tube connected to a water pipe of faucet water, and with its water output tube connected to a filtering core; around the water input tube and the water output tube are each sleeved with a sound silencing cotton sleeve, while a sound silencing cotton layer is disposed between outer perimeter of the pump assembly and the shell body, as such the method includes following steps: in installation, firstly, placing the sound silencing cotton layer in an inner chamber of the pump assembly; next, sleeving the sound silencing cotton sleeve around and onto the water input tube and the water output tube of the pump assembly, to ensure that the sound silencing cotton sleeve and the sound silencing cotton layer are fixedly positioned and not tends to slip; finally inserting the pump assembly into the sound silencing cotton layer, to finish installation of the pump assembly in the shell body.

8. The low-noise vibration-reduction water purifier installation method as claimed in claim 7, wherein the pump assembly includes:
a pump;
a seat rack, used to position the pump, including a bottom seat, and a middle seat located above the bottom seat;
wherein, the pump is locked and fixed on the middle seat, while perimeter of the middle seat is provided with a plurality of through holes, in the through holes are each provided with an indent flange, below the indent flange is provided with a lower spring, that is disposed to penetrate into a sinking hole of the bottom seat, above the indent flange is provided with an upper spring, a bolt component is disposed to penetrate through the through hole and the sinking hole, such that the bolt component is disposed to press the upper spring and the lower spring, to fix the middle seat onto the bottom seat, as such the method includes following steps:
in installing the pump assembly, firstly, putting the lower spring into the sinking hole, next, placing the upper spring above the indent flange in the through holes, then, placing the pump fixed with the middle seat in advance into the bottom seat, to penetrate the sinking hole and the through holes from bottom to top, to connect to the bolt component.
